(19) United States
(12) Patent Application Publication
(10) Pub. No.: US 2005/0177477 A1
(43) Pub. Date: Aug. 11, 2005

(54) "Time clock", "time sheet" and "payroll calculator" software

(76) Inventors: Kamran Arghavanifard, Los Angeles, CA (US); Albert Kahen, Los Angeles, CA (US)

Correspondence Address: Kamran Arghavanifard / Albert Kahen, 998 S. Robertson Blvd. # 103 A, Los Angeles, CA, 90035, US

(21) Appl. No.: 10/749,091

(22) Filed: Dec. 31, 2003

(51) Int. Cl. G06F 17/60

(52) U.S. Cl. 705/32

(57) ABSTRACT

A multi user computer software which works as a “Time Clock”, “Time Sheet”, “Payroll Calculator”, “Tax Calculator”, “Check Print Out”, “Check-stub Print Out”, “Monthly Tax Deposits”, “Quarterly Tax Payments” and “Annually Tax Payments” all in one package. This Software can be installed on a Personal-computer, work-station computer or on a Central-computer with networking capability.

### REFERENCES CITED

### U.S. Patent Documents

| | | | |
|---|---|---|---|
| 6356875 | March, 2002 | Green et al. | 705/9 |
| 6347306 | February, 2002 | Swart | 705/32 |
| 6049776 | April, 2000 | Donnely et al | 705/8 |
| 5877953 | March, 1999 | Clendenen et al. | 700/17 |
| 5717867 | February, 1998 | Wynn et al. | 705/32 |
| 4819162 | April, 1989 | Webb, Jr. et al. | 705/32 |
| 4324975 | April, 1982 | Rees | 235/70A |
| 4323771 | April, 1982 | Chalker, Jr. et al. | 235/377 |
| 4270043 | May, 1981 | Baxter et al. | 235/419 |

### Foreign Patent Documents

| | | | |
|---|---|---|---|
| 408180115 | July, 1996 | JP | 705/32 |
| 05-028337 | February, 1993 | JP | |
| 558574 | January, 1975 | CH | |

### BACKGROUND OF THE INVENTION

1. Field of Invention

A multi user computer software which works as a “Time Clock”, “Time Sheet”, “Payroll Calculator”, “Tax Calculator”, “Payroll Check Print Out”, “Monthly Tax Deposit”, “Quarterly Tax Payment” and “Annually Tax Payment” all in one package. This Software can be installed on a Personal-computer, work-station computer or on a Central-computer with networking capability. To be used in small business and large corporations alike.

2. Description of the Prior Art

Regarding “Time Clock” portion of this Software, traditionally a separate utility equipment or an electronically swipe card or an actual clock is used to record the time entry, or punch numbers or holes on so-called punch cards. These punch clocks not only aren't always accurate, one must also calculate the hours manually and round off the minutes for easier calculation of the Gross payroll.

Regarding “Time Sheet” portion of this Software, traditionally makeshift charts are made where one must input his/her own date and time. Usually no total regular hour and over time hours are calculated or total breaks deducted with traditional systems.

Regarding “Payroll Calculations” and “Tax Deductions” portion of this Software, traditionally employers must provide the time sheet or time sheet and gross payroll amount to a data processing or accounting firm. These entities then calculate the deductions and provide the employee's payroll checks by mail or via electronic direct deposits. In doing so only these firms will be able to calculate the monthly tax deposit and quarterly tax payments for the employer. Therefore the employer, specially the small business owner, is always at the mercy of these firms to provide him with the necessary information that he needs at a very high monthly fee. But by using this software, employer has an accurate control on calculating the time-entries, payroll amount, the monthly tax deposit and quarterly tax payments without getting help from theses vendors or accounting offices at a high cost.

Regarding “Check Print Out” portion of this Software, traditionally one must manually input the check amount and date of issue and payroll period. With this software the amount of payroll check is calculated accurate and automatically with a check stub and all deductions and taxes. Showing the payroll period's deduction on one side and year-to-date deductions on another column. The employer has the option to print out payroll checks immediately at the end of each payroll period.

### BRIEF SUMMERY OF THE INVENTION

In accordance with the Invention, this either single or multi user Software is intended to eliminate all the middlemen and other equipment and software, which is traditionally used at a utilization fee or purchase fee, to process a payroll from the attendance time of an employee to that last process which is issuing a payroll check to the employees. It also calculates all the taxes due for payment by the employer.

This software will replace existing mechanical time clocks by recording the exact daily attendance time of “Sign-in”, “Sign-out” and “Break-time” hours for employees. This software stores all employees' human resource information.

This software calculates the total working hours, total break hours, total overtime hours, total days off and total sick days for any payroll period and will replace any time sheet which traditionally is used.

This software automatically and immediately calculates Gross income for any payroll period.

This software automatically and immediately calculates all Deductions and Taxes.

This software automatically and immediately calculates Net pay.

This software automatically and immediately prints out Pay-Check for employees with check stubs showing the deductions.

The Paycheck and check stub is provided immediately for one employee or as a batch for that particular payroll period for multiple employees.

This software is also intended for an in house record keeping and employers State and Federal tax payments on monthly, quarterly and yearly bases.

This software calculates monthly Tax deposit for any particular pay period or any month and a year to date calculations is also provided.

This software also calculates quarterly Tax payments and Annually Tax payment.

This software saves all the above documentation for annual record and end year deductions and taxes.

Intention of this Invention is also to save the small business owners and the larger corporations thousands or even tens of thousands of dollars by utilizing this single all in one program. Any small business from one employee to a large corporation can utilize this software without any special programming, extra man power or man hour or any payroll or human resource or accounting knowledge.

### BRIEF DESCRIPTION OF DRAWINGS

FIG. 1.

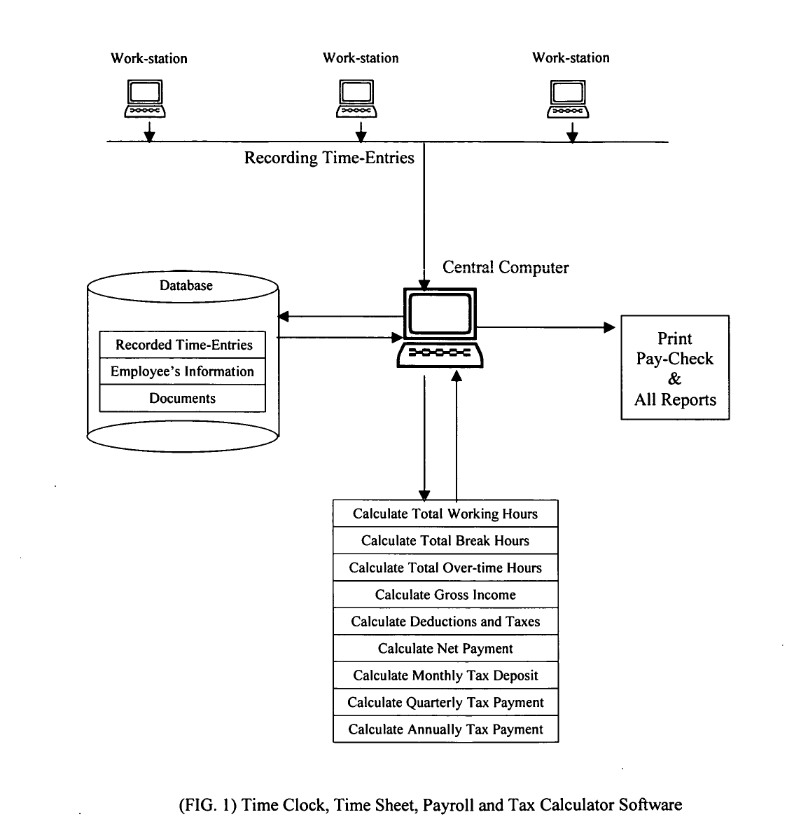

Shows a general schematic of the Software, which indicates how data transfers between employees, Central computer and Database. (In a networking computer system)

FIG. 2.

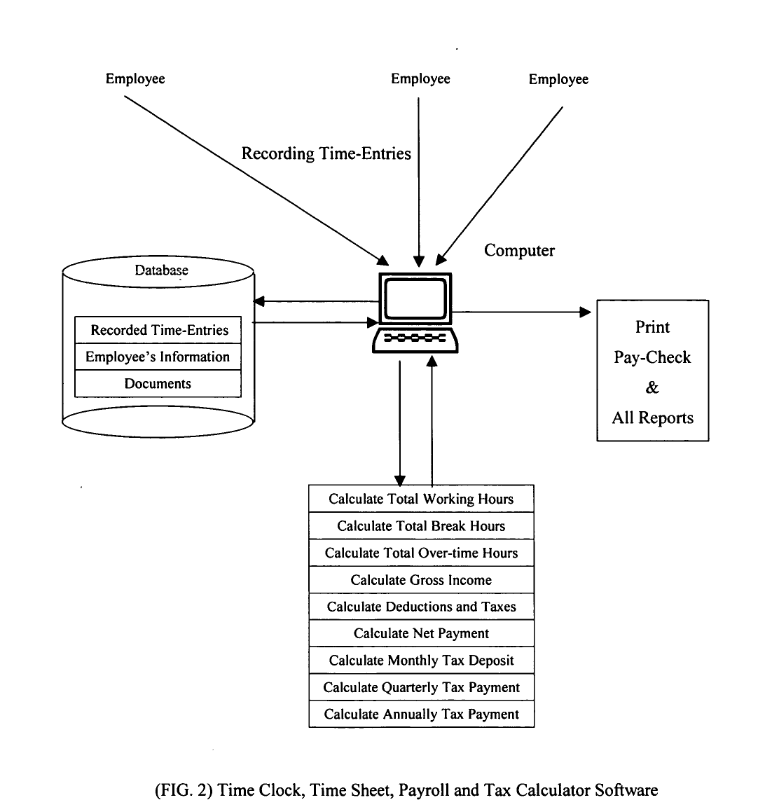

Shows a general schematic of the Software, which indicates how data transfers between employees, computer and Database. (If there is no networking computer system)

FIG. 3.

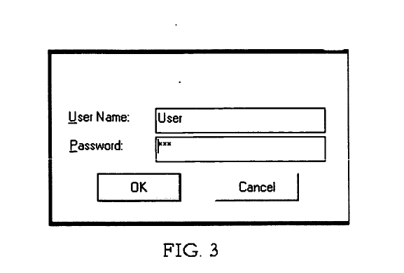

Shows the first page of the Software which, is the Entrance to the Software and enables one to use it as an employee or as a Supervisor.

FIG. 4.

Shows the second page of the Software which, is the Main page and enables employees to record their “Sign-In”, “Sign-Out”, “Going to Break” and “Coming Back from Break” times.

FIG. 5.

Shows the “View Hours” page of the Software, which provides a summery of time-entries of an employee and calculates total regular, over-time and Break-time for the specific given payroll period.

FIG. 6.

Shows the “View Payroll” page of the Software that provides a summery of time-entries of an employee and calculates total regular, over-time and Break-time for the specific given payroll period and calculates the Gross payroll, all Deductions and Net payroll with ability to save document.

FIG. 7.

Shows the “Update Hours” page of the Software, which provides a screen if one needs to update or make correction on the time-entries for employees.

FIG. 8.

Shows the “Add Employee” page of the Software, which provides a page for adding unlimited number of employees and employees' information in the Database.

FIG. 9.

Shows the “Update Employee” page of the Software, which provides a page if one needs to update or make correction on the employee's personal information.

FIG. 10.

Shows the “Delete Employee” page of the Software, which provides a page if one needs to delete employee's personal information.

FIG. 11.

Shows the “Pay Check” page of the Software, which provides a page if one needs to Print Pay-check for any payroll period.

FIG. 12.

Shows the Federal and State fixed percentage of Tax rate and Tax tables, which provides a page if one needs to update this information.

FIG. 13.

Shows the “Quarterly Tax Payment” page of the Software, which provides a page if one needs to Print Quarterly Tax Payment.

FIG. 14.

Shows the “Monthly Tax Deposit” page of the Software, which provides a page if one needs to Print Monthly Tax Deposit.

FIG. 15.

Shows the “Annually Tax Payment” page of the Software, which provides a page if one needs to Print Annually Tax Payment.

FIG. 16.

Shows the “Entering Day-Off” page of the Software, which provides a page if one needs to Record the days off dates for employees.

### DETAILED DESCRIPTION OF THE INVENTION

The Invention is a single or multi user computer software where it can be installed on a Personal-computer, Work-Station computer or Central computer:

1. To keep track of time of employee's work start, Breaks and time of exit as a Time-Clock.

2. To provide a time sheet for any payroll period.

3. To record the days off for employees.

4. To calculate Gross, Deductions and Net Income.

5. To save document and produce a payroll check.

6. To calculate total of all payroll Taxes for monthly tax deposits and quarterly and annually tax payments.

This new Software provides an employer with the option to have all of the above tools at his/hers disposal all in one package.

Architecture and Environment of this Software:

This Software is written in “Microsoft Windows” Environment and The Programming Language being used is “Microsoft Visual Basic” and The Database being used is “Microsoft Access”. Every employee directly stores in the Database the time for starting work, going to break, Coming back from break and stopping the work by just clicking on the related Button on the main page of the Software.

This Software uses the internal Date/Clock system of the computer.

When Supervisor runs this Software on the computer, he will see a page (FIG. -3) on the screen of the computer. He has to enter the password on this page and then login to program as a Supervisor. Notice that only Supervisor has access to all part of the Software. Supervisor is able to add the information of the employees and assign to everyone an ID number.

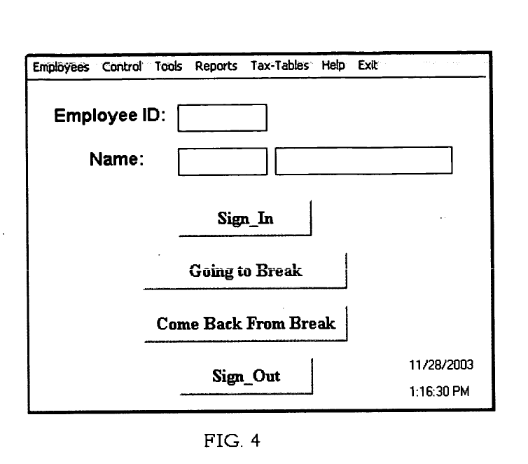

Now System is ready. Every employee can run this Software on either the Server computer or his own work-station computer in his room. When he runs this software, he will see page (FIG. -3) on the screen of the computer. On this page employees are as a User, So they don't need to enter the Password. They just have to click on “OK” button, then second page, which is the main page of the Software will appear (FIG. 4). Notice that if you start this Software with no Password you don't have access to other part of the Software except by the main page, which is provided to employees to enter their Time-Entries.

Recording the Time-Entry:

1. When an employee wants to start work, on the main page (FIG. 4) each employee first types his/her ID and then automatically his/her name will appear under the ID. Then he/she clicks on “Sign-In” button. A message will appear and for confirmation will ask employee if wants to Sign-In. Answer “Yes” to confirm or answer “No” to cancel it.

2. When an employee wants to go to break, employee just needs to enter his/her ID and then click on “Going to Break” button. Again a message will appears confirming it.

3. When an employee wants to Come Back from break, he just needs to enter his ID and then click on “Coming Back from Break” button. Again a message will appears to confirm it.

4. When an employee wants to stop working, he just needs to enter his ID and then click on “Sign-Out” button. Again a message will appears to confirm it.

Entering Employee's Information:

When a supervisor runs this program, first he will enter his password to have ability to add or update the employees' information.

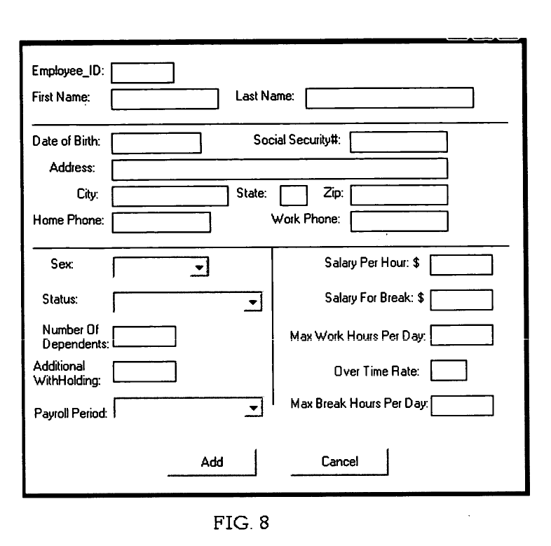

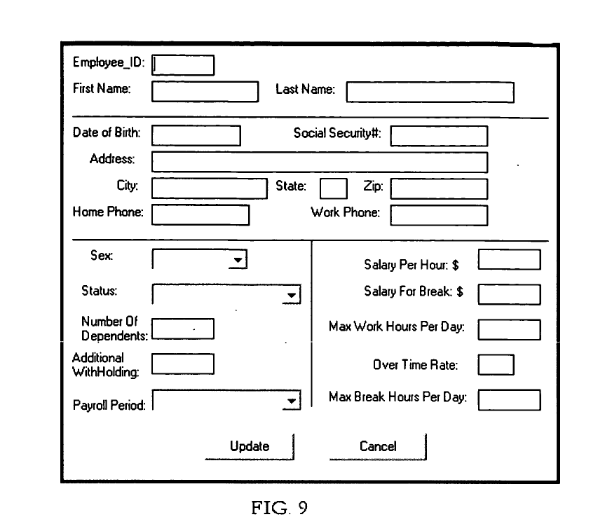

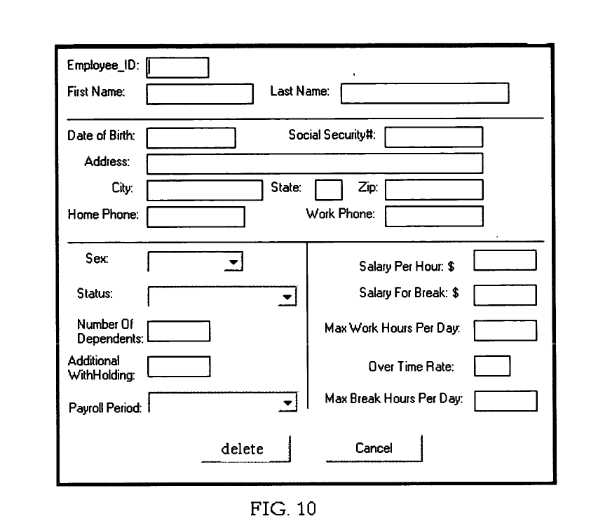

Click on “Employees” menu on (FIG. 4) and then select “Add new Employee” option. On the new screen (FIG. 8) Supervisor can fill the form and add information for a new employee. Also, by clicking on “Update employee” or “Delete employee” supervisor can update or delete information of an employee. (FIG. 9) and (FIG. 10)

Reviewing the Recorded Times:

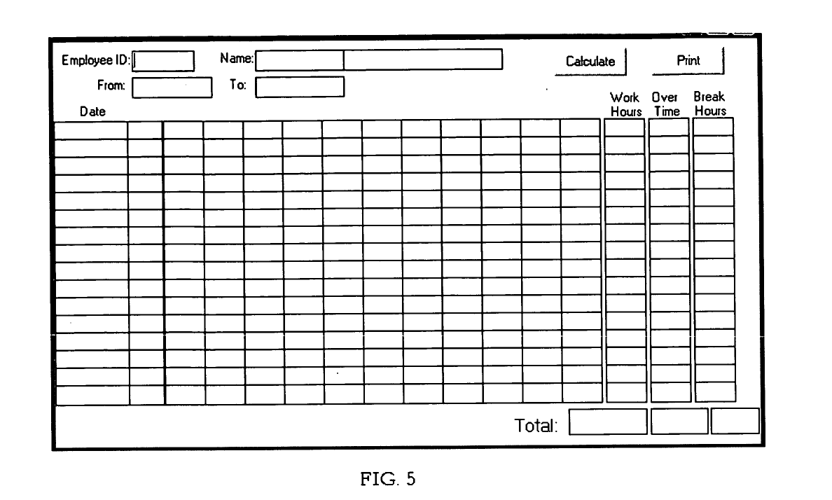

Supervisor can simply go to Menu and then click on the “Control” then click on “View Hours”. On this screen (FIG. 5) first enter the employee ID then the beginning-date and end-date of payroll period. Then click on “Calculate” button. A report will show the employee's time_entries for the indicated payroll period.

Changing or Making Correction on the Recorded Times:

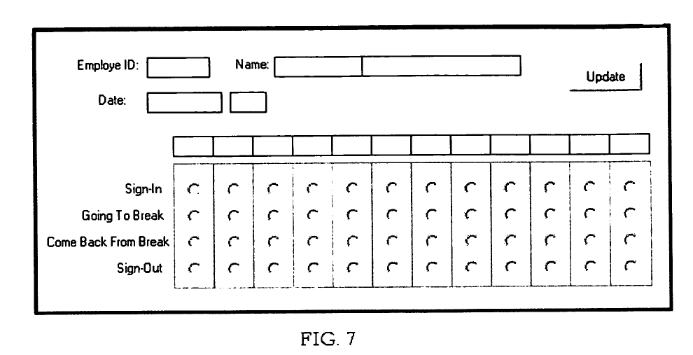

If an employees forgets to Sign-In or Sign-Out on the computer then Only the Supervisor is able to change or make correction on the recorded times. First he goes to Menu and clicks on “Control” button. Then he clicks on “Update Hours”. On this screen (FIG. 7) first enters employee ID then date of the day he wants to change. Then he can update the recorded times and indicate that each specific time is for “Sign-In”, “Sign-out”, “Go to Break” or “Come back from Break”. Then clicks on “Update” button. A message will ask him to confirm this transaction.

Entering Employee's Day-Off:

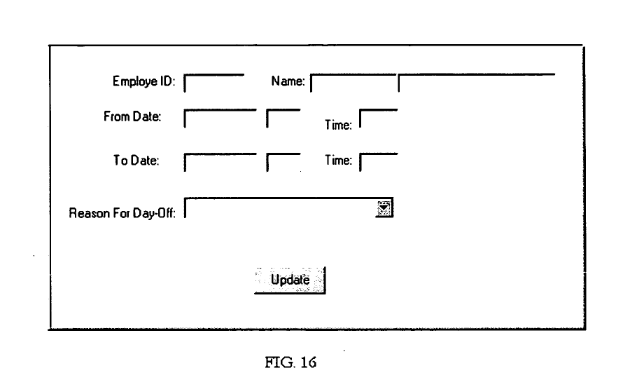

A Supervisor has to click on Menu and then “Control” button. Then select option “Entering Day-off”. On this page (FIG. 16) enters employee ID then dates for day off. Also indicating the reason for day off and indicating that this day off is with pay or without pay.

Calculating Payroll:

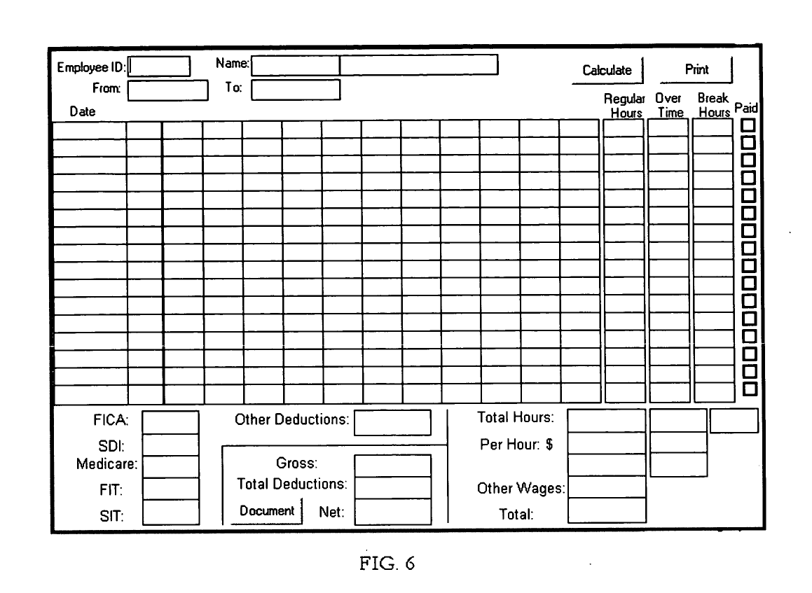

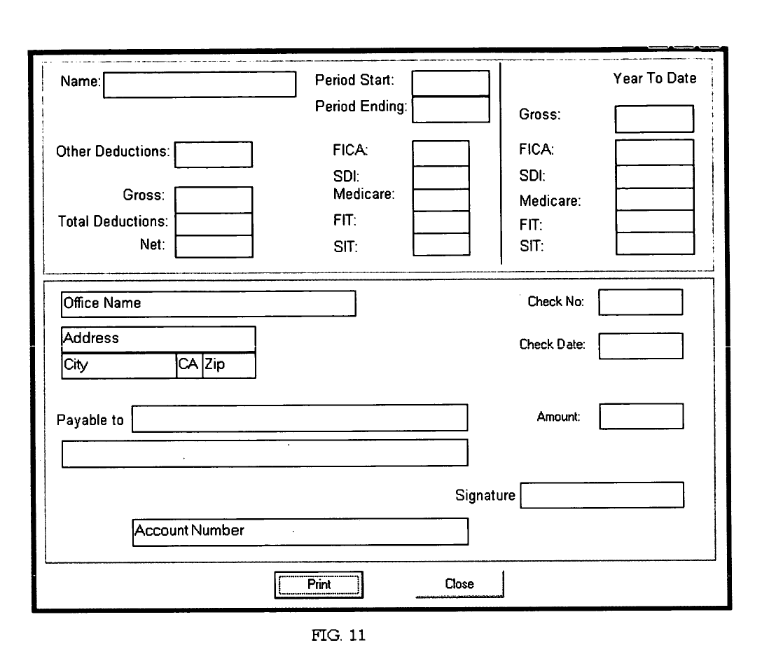

A Supervisor has to click on Menu and then “Control” button. Then select option “View payroll”. On this page (FIG. 6) enters employee ID then payroll dates worked from to. Then clicks on “Calculate” button. Software automatically calculates all the working hours and break hours and over-time hours. Then multiples total working hours by the salary per hour. On the right side and the bottom of the screen you will see the Gross Income. Now on the left side and the bottom of this screen you will see all the Deductions and Taxes. On this page also you are able to add any other Wages or Deductions. Finally, Software calculates the Net payment. Now you are able to print payroll check and payroll check stub. (FIG. 11).

Also you are able to save this payroll on the employee's File. Simply click on the “Document” button and then on the new screen enter the Check-Number, Check-Date, Check-Amount and Check-Notes. Then click on the “Save Document” button.

Issuing Monthly Tax Deposit, Quarterly and Annually Tax Payments:

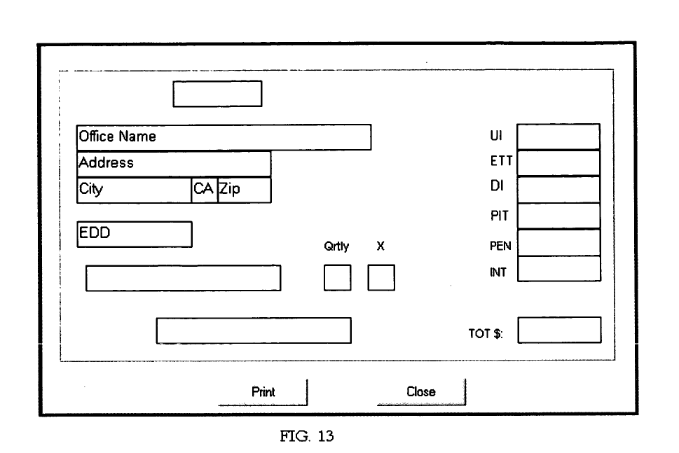

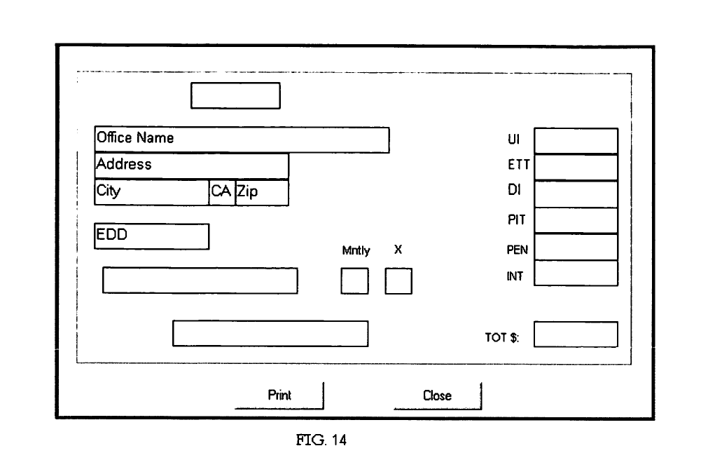

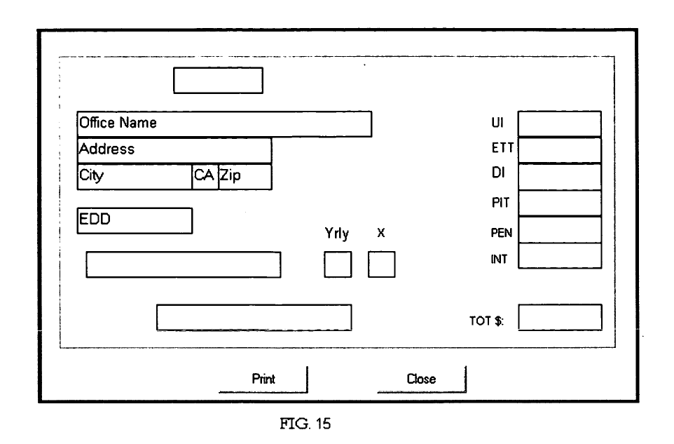

A Supervisor has to click on menu and then “Control” button. Then select option “Monthly Tax Deposit” or “Quarterly Tax Payment” or “Annually Tax Payment”. On this page (FIG. 13), (FIG. 14) and (FIG. 15) enter employee ID then dates. Then click on “Calculate” button. Software automatically calculates all the monthly, quarterly or annually payments.

Changing or Making Correction on Tax Rates:

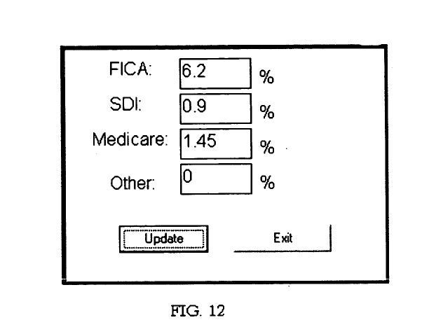

If the rates for Federal Tax or State Tax changes, then Supervisor is able to update this information on the Database. He has to go to Menu and click on “Tax-Table” button (FIG. 12). Then he will see the rates for the Taxes. Now he can update this information.

1. A multi user Software which, is able to record “Time-In”, “Time-Out” and “Break-Time” hours for employees directly into a Database by using only a computer not any other hardware.

2. The said Software in claim 1 can be installed on a Personal computer, work-station computer or on a Central-computer with networking capability.

3. The said Software in claim 1 enables any employees to use the computer and record their “Time-In”, “Time-Out” and “Break-Time” hours by just entering their employee ID in the computer and clicking on the mouse.

4. The said Software in claim 1 uses the internal Date/Clock system of the computer for recording the “Time-In”, “Time-Out” and “Break-Time” hours.

5. The said Software in claim 1 displays employee's name after entering employee ID.

6. The said Software in claim 1 rejects an error if an employee enters a wrong employee ID.

7. The said Software in claim 1 is able to calculate and print the regular-working hours, over-time hours and break-time hours for any payroll period from the recorded hours in the claim 3 via the Database.

8. The said Software in claim 1 is able to record and deduct days-off and make payroll amount ready by calculating days off with pay or days off without pay.

9. The said Software in claim 1 is able to calculate the Gross payroll, Tax, Deductions and Net pay from calculated regular-working hours, over-time hours and break-time hours in the claim 7.

10. The said Software in claim 1 is able to in case of employees on salary only, calculate payroll and taxes by input the base salary and any other income or commission data.

11. The said Software in claim 1 is able to print and issue a pay-check from calculated Net pay in the claim 9 and 10.

12. The said Software in claim 1 is able to print and issue a pay-check Stub from calculated Net pay in the claim 9 and 10.

13. The said Software in claim 1 is able to calculate total of all payroll Taxes for monthly tax deposits.

14. The said Software in claim 1 is able to calculate total of all payroll Taxes for quarterly tax payments.

15. The said Software in claim 1 is able to calculate total of all payroll Taxes for annually tax payments.

16. The said Software in claim 1 has two different accesses into the said Database. One by Supervisor and one by the employees. The Supervisor has access to all parts of the said Software, but employees have access to the only one part of the said Software which includes only “Time-In”, “Time-Out” and “Break” hours in the claim 3.

17. The said Software in claim 1 enables the Supervisor to add, update and delete the information of the said employees in the said Database.

18. The said Software in claim 1 enables the Supervisor to add, update and delete the “Time-In”, “Time-Out” and “Break-Time” hours of the employees in the Database.

19. The said Software in claim 1 Includes all the claims From claim 2 through claim 18 all in one program. All of the claims 2 through 18 are inclusive and dependent on each other.
